(19) United States
(12) Patent Application Publication
(10) Pub. No.: US 2020/0169157 A1
(43) Pub. Date: May 28, 2020

(54) TRANSPORT DEVICE IN THE FORM OF A LONG-STATOR LINEAR MOTOR

(71) Applicant: B&R INDUSTRIAL AUTOMATION GMBH, Eggelsberg (AT)

(72) Inventor: Andreas WEBER, Eggelsberg (AT)

(73) Assignee: B&R INDUSTRIAL AUTOMATION GMBH, Eggelsberg (AT)

(21) Appl. No.: 16/695,419

(22) Filed: Nov. 26, 2019

(30) Foreign Application Priority Data
Nov. 27, 2018 (EP) 18208683.5

(51) Int. Cl. H02K 41/03; B65G 23/23

(52) U.S. Cl. CPC H02K 41/031; B65G 23/23

(57) ABSTRACT

In order to specify a transport device in the form of a long-stator linear motor, which includes a transport path along which at least two transport units can be moved in the longitudinal direction, and which allows for more flexible operation, the magnetic poles of the at least two transport units have a different pole pitch.

### CROSS-REFERENCE TO RELATED APPLICATIONS

The present application claims priority under 35 U.S.C. § 119(a) of Europe Patent Application No. 18 20 8683.5 filed Nov. 27, 2018, the disclosure of which is expressly incorporated by reference herein in its entirety.

### BACKGROUND

### 1. Field of the Invention

The invention relates to a transport device in the form of a long-stator linear motor, comprising a transport path along which at least two transport units can be moved in the longitudinal direction, a plurality of drive coils being arranged one behind the other in the longitudinal direction on the transport path and a plurality of magnetic poles being arranged one behind the other in the longitudinal direction on the transport units at a specific pole pitch in each case, which interact electromagnetically with the drive coils to move the transport units, each magnetic pole comprising at least one permanent magnet. Furthermore, the invention relates to a transport unit for a transport device in the form of a long-stator linear motor, and to a magnetization device for a transport unit of a transport device in the form of a long-stator linear motor, and to a method for operating a transport device in the form of a long-stator linear motor.

### 2. Discussion of Background Information

In a long-stator linear motor, a plurality of electrical drive coils forming the stator are arranged next to one another in a stationary manner along a transport path. A transport unit has a number of drive magnets arranged thereon, either as permanent magnets or as electrical coils, which interact with the drive coils. The (electro) magnetic fields of the drive magnets and the drive coils interact to generate a driving force on the transport unit that moves the transport unit forward. The long-stator linear motor can be designed as a synchronous machine, both self-excited or externally excited, or as an asynchronous machine. By actuating the individual drive coils, for regulating the magnetic flux, the size of the driving force is influenced and the transport unit can be moved in the desired manner along the transport path. It is also possible to arrange a plurality of transport units along the transport path, the movements of which can be controlled individually and independently of one another by the drive coils which each interact with a transport unit being energized, generally by applying an electrical voltage.

The drive coils of the long-stator linear motor are usually energized individually by power electronics units by the power electronics units applying the coil voltages predetermined by the control to the drive coils. The power electronics units are of course designed for a maximum current or a maximum voltage, whereby, with a given structural design of the long-stator linear motor, the achievable driving force and achievable speed of a transport unit is predetermined. For a large speed range and a high driving force, therefore, the power electronics units, but also the drive coils, must therefore be designed to be accordingly powerful. With the high number of drive coils and power electronics units of a long-stator linear motor, this is of course associated with high complexity and costs, and therefore is generally undesirable.

A long-stator linear motor is distinguished in particular by better and more flexible utilization over the entire working range of the movement (position, speed, acceleration), individual regulation/control of the transport units along the transport path, improved energy utilization, the reduction of maintenance costs due to the lower number of wearing parts, a simple exchange of the transport units, efficient monitoring and fault detection and optimization of the product flow along the transport path. Examples of such long-stator linear motors can be found in WO 2013/143783 A1. U.S. Pat. No. 6,876,107 B2, US 2013/0074724 A1 or WO 2004/103792 A1.

In most cases, the transport units of a transport device are identical, which has the advantage that they are easily exchangeable, for example in the event of a defect or maintenance.

U.S. Pat. No. 8,427,015 B2 and U.S. Pat. No. 8,674,561 B2 disclose transport devices in the form of a long-stator linear motor, once in a coreless design and once with coil cores. In this case, the drive coils are arranged on the transport unit and the permanent magnets are arranged on the stator. In order to achieve transport units having different degrees of thrust, with the overall length of said units not differing significantly, it is proposed that the ratios of the number of permanent magnets to the number of drive coils differentiate a transport unit having high thrust and a transport unit having low thrust. The length of the transport units is dependent on the number of permanent magnets that interact with the drive coils. The disadvantage here is both that the transport units require a power supply for the drive coils and that different sizes of drive coils are necessary for the different transport units, which is very expensive.

### SUMMARY

The problem addressed by embodiments of the invention is therefore to provide a transport device in the form of a long-stator linear motor that allows for more flexible operation.

According to embodiments, the problem is solved in that the magnetic poles of the at least two transport units have a different pole pitch. As a result, a plurality of transport units having different maximum achievable speeds can be used on the transport path. If the pole pitch is increased, the self-induction voltage at the drive coils is reduced, whereby the maximum achievable speed is increased, and vice versa. Under certain circumstances, a field-weakening mode of the long-stator linear motor can be taken into account, by which the maximum achievable speed level can be additionally increased. Therefore, different maximum speeds of the transport units can be made possible under a defined load substantially without changing the energetic boundary conditions (maximum current or maximum voltage of the power electronics units) of the transport device.

If the at least two transport units have a different number of magnetic poles and/or the magnetic poles of the at least two transport units have a different pole width, the maximum achievable driving force of the transport unit can be influenced.

According to an advantageous embodiment of the invention, it is provided that a number of the magnetic poles and/or the pole pitch and/or a pole width of the magnetic poles can be changed on at least one transport unit during the movement of the transport unit along the transport path and/or when stationary, at least one permanent magnet of a transport unit preferably being interchangeable for changing the number of the magnetic poles and/or the pole pitch and/or the pole width of the magnetic poles. As a result, a plurality of transport units can be adapted individually to desired boundary conditions with regard to the maximum achievable speed and driving force. If the change takes place during the movement of the transport unit, it is e.g. not necessary to remove the transport unit from the transport path for changing the maximum achievable speed, as a result of which the movement sequence can be optimized in terms of time. The change can also take place when stationary, for example by the transport unit being removed from the transport path.

Advantageously, a magnetization device is provided in the transport device for changing the number of the magnetic poles and/or the pole pitch and/or the pole width of the magnetic poles, by which magnetization device magnetic properties of at least one permanent magnet of a transport unit can be changed, the magnetization device being integrated in the transport path of the transport device or being arranged in parallel with the transport path. As a result, the maximum achievable speed can be changed easily and flexibly.

Preferably the magnetization device comprises a magnetization unit and a magnetization control unit, the magnetization unit being provided to generate a magnetic field in order to change the magnetic properties of at least one permanent magnet of the transport unit, in order to change the pole pitch of the magnetic poles, wherein the magnetization control unit is provided for actuating the magnetization unit.

Preferably, the magnetization unit is provided to generate a magnetic field in order to change magnetic properties of at least one permanent magnet of the transport unit in order to change a number of the magnetic poles and/or a pole width.

It is further advantageous, if the magnetization unit for generating the magnetic field comprises at least one magnetization coil, which preferably comprises a magnetization coil width which corresponds to a magnet width of a permanent magnet of the transport unit or to an integer multiple of the magnet width of a permanent magnet of the transport unit. As a result, for example, the magnetic properties of a plurality of permanent magnets one behind the other can be changed in a targeted manner using only one magnetization coil width.

If the magnetization device is integrated in a transport path of a transport device in the form of a long-stator linear motor, it is advantageous that at least one of the drive coils of the transport path is designed as magnetization coil of the magnetization unit. If the magnetization device is arranged in parallel with a transport path of a transport device in the form of a long-stator linear motor, it is advantageous, if the magnetization device being stationary or movable relative to the transport path in order to change the magnetic properties of at least one permanent magnet of the transport unit when stationary or during the movement of the transport unit.

According to a further advantageous embodiment of the invention, it is provided that a position of at least one permanent magnet in the longitudinal direction of the transport unit can be changed by an adjusting device arranged on the transport unit for changing the pole pitch of the magnetic poles of a transport unit. As a result, a mechanical or electromechanical adjusting device can for example be provided, by which the maximum achievable speed can be changed easily and flexibly when stationary or during movement.

Preferably, a coil pitch of the drive coils in the longitudinal direction along the transport path differs from the pole pitch of the transport units, the coil pitch preferably being constant over the entire transport path. As a result, the negative effect of cogging can be prevented.

The problem is also solved by a transport unit on which the pole pitch of the magnetic poles of the transport unit can be changed, an adjusting device preferably being provided on the transport unit, by which device a position of at least one of the permanent magnets in the longitudinal direction of the transport unit can be changed in order to change the pole pitch. Particularly preferably, the adjusting device is mechanically constructed and comprises a transmission or a rod assembly and/or at least one spring element for adjusting the pole pitch or the adjusting device is electromechanically constructed and comprises at least one electromechanical actuator and a control unit for actuating the actuator, in order to change the pole pitch. As a result, the pole pitch can be changed during the movement of the transport unit or when stationary, for example also away from the transport path.

Advantageously, the transport unit comprises a triggering unit for triggering the adjustment of the pole pitch, it being possible to actuate the triggering unit manually or by an actuating unit of a transport device in the form of a long-stator linear motor. This makes it possible, for example, to trigger the adjustment of the pole pitch automatically at a certain point on the transport path.

According to a further advantageous embodiment, at least one permanent magnet of the transport unit is exchangeable for changing the pole pitch and/or a number of the magnetic poles and/or a pole width of the magnetic poles and/or in that the magnetic properties of at least one permanent magnet can be changed by a magnetization device. This provides an alternative option for changing the pole pitch without complex mechanisms, and in addition the number of the magnetic poles and/or the pole width can be changed, as a result of which the maximum driving force can be influenced.

The problem is also solved by the method mentioned at the outset, in which at least two transport units are used in the transport device, the magnetic poles of which have a different pole pitch.

Particularly preferably, the pole pitch and/or a number of the magnetic poles and/or a pole width of the magnetic poles is changed on at least one transport unit during the movement of the transport unit along the transport path and/or when stationary.

Other exemplary embodiments and advantages of the present invention may be ascertained by reviewing the present disclosure and the accompanying drawing.

### BRIEF DESCRIPTION OF THE DRAWINGS

The present invention is described in greater detail in the following with reference to FIG. 1 to 4, which show exemplary, schematic and non-limiting advantageous embodiments of the invention. In the drawings:

FIG. 1 shows a transport device in the form of a long-stator linear motor,

FIG. 2A-2B show a transport unit comprising mechanically adjustable magnetic poles,

FIG. 3A-3D show a transport unit having different pole pitches,

FIG. 4 shows a magnetization device on a transport path.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

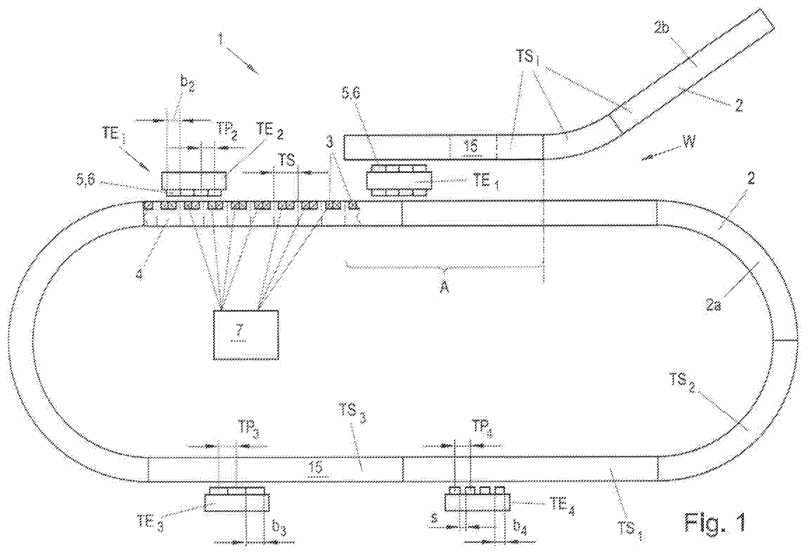

FIG. 1 shows a transport device 1 according to the invention in the form of a long-stator linear motor. The transport device has, in a known manner, a transport path 2 along which a plurality of transport units TEi can be moved (the index i represents the relevant transport unit TE1-TEi). The transport path 2 forms the stator of the long-stator linear motor and comprises a plurality of drive coils 3, which are arranged one behind the other in the longitudinal direction. The transport path 2 can, as in the example shown, also comprise a plurality of transport segments TSi, on each of which a plurality of drive coils 3 are arranged. This allows for a modular design and transport paths 2 having a wide range of geometries can be constructed from a few standardized transport segments TSi. By way of example, FIG. 1 shows a straight transport segment TS1 and a curved transport segment TS2. Such a modular construction is known from the prior art, and other embodiments of the transport path 2 or transport segments TSi would of course also be conceivable.

The drive coils 3 are generally arranged at a constant spacing, which is known as the coil pitch TS, so as to be spaced apart in the longitudinal direction on the transport path 2, the coil pitch TS referring to the spacing of the coil axes. The coil pitch TS is generally constant over the entire transport path 2, in order to generate the most uniform magnetic field in the longitudinal direction. In the example shown, the drive coils 3 are arranged on teeth of a ferromagnetic core 4 (for example, an iron laminated core). The drive coils 3 could also be designed to be coreless, however. The transport units TEi each comprise a plurality of magnetic poles 5, which, when viewed in the longitudinal direction, are spaced apart from one another at a pole pitch TP, the pole pitch TP referring to the center of a magnetic pole 5 in each case (when viewed in the longitudinal direction). In this case, a magnetic pole 5 has at least one permanent magnet 6, but may of course also have a plurality of permanent magnets 6 arranged next to one another and having a rectified magnetization, i.e. the same polarity, as will be explained in detail below.

In a known manner, an air gap is provided between the transport units TEi and the drive coils 3 of the transport path 2, as shown in FIG. 1. In order to keep the air gap as constant as possible along the entire transport path 2, a guide device (not shown) is generally also provided for guiding the transport units TEi on the transport path 2. Such a guide device is not absolutely necessary, but it is advantageous, in addition to maintaining the air gap, to ensure that the transport units TEi, in particular in curves, do not fall from the transport path 2. For example, a guide rail could be provided on the transport path 2, and rollers guided therein could be provided on the transport units TEi. Such guides comprising different guide elements, such as rollers, wheels, sliding surfaces, magnets, etc., are known, which is why this will not be discussed in greater detail here.

Of course, the transport path 2 could also be entirely or partly in the form of a so-called double-comb design, as shown by way of example with reference to the transport path portion A in FIG. 1. Here, the transport path 2 has, in the transverse direction (transversely to the longitudinal direction), spaced-apart transport path portions 2a, 2b, between which the transport units TEi can be moved. Here, the transport path portion 2a extends in the path portion A in parallel with the second transport path portion 2b, which is designed to be closed here. In the region of a switch W, the two transport path portions 2a, 2b diverge, it being possible for the transport units TEi to be transferred from the first transport path portion 2a to the second transport path portion 2b in the switch W, or vice versa, depending on the direction of movement. In the region of the double comb (transport path portion A), drive coils 3 can of course in turn be arranged on the second transport path portion 2b which interact with magnetic poles 5 of the transport units TEi, which are preferably provided on either side of the transport units TEi in the transverse direction, as shown by way of example for the transport unit TE1. The advantage of the double-comb design is, for example, that a higher driving force can be exerted on the transport unit TE1, because magnetic poles 5 interact with drive coils 3 on either side of the transport unit TE1, which e.g., may be required or advantageous for moving heavy loads or on gradients or for high acceleration. If a transport unit TEi only has magnetic poles 5 on one side, as in the remaining transport units TEi shown, only the guide of the second transport path portion 2b, for example, may be used to additionally guide the transport unit TEi, without generating an additional driving force.

The movement of the transport units TEi is generally controlled by one or more control unit(s) 7 (hardware and/or software), which actuate or control the drive coils 3 according to a desired movement sequence. For this purpose, a specific target movement sequence in the form of target values can be predetermined, for example a specific target position and/or target speed and/or target acceleration of a transport unit TEi. The control unit 7 supplies the drive coils 3 with a corresponding voltage and/or a current in order to maintain or reach the predetermined target values. Essentially, the drive coils 3 are supplied with voltage/current such that a magnetic field moved in the longitudinal direction relative to the transport path 2 is generated by the drive coils 3, which field interacts with the magnetic poles 5 to move the transport units TEi. Of course, sensors (not shown) required for the control may be provided on the transport path 2 (or the transport units TEi) for detecting actual values, e.g. an actual position or actual speed. In the simplest case, however, instead of feedback control, mere feedforward control can also be used, for example when the boundary conditions and influencing factors of the movement are known (e.g. known, defined movement sequence of the transport units TEi, known transported load, etc.).

As mentioned at the outset, the maximum achievable speed of a transport unit TEi for a predetermined structural design of the transport device 1 is substantially limited by a maximum coil voltage and/or a maximum coil current which can be applied to the drive coils 3 by power electronics. The maximum coil voltage or the maximum coil current is usually predetermined by the structural design of the transport device 1 and in particular the power electronics of the drive coils 3 and can or should not be exceeded, so as not to damage the drive coils 3 and the power electronics. In order to still allow for selectively different maximum achievable speeds at a given load of the transport units TEi on the transport device 1, it is provided according to the invention that the magnetic poles 5 of the at least two transport units TEi have a different pole pitch TP, the pole pitch TP of all the magnetic poles 5 of a transport unit TEi preferably being constant. By varying the pole pitch TP, the maximum achievable speed of the transport units TEi can be influenced. In principle, it generally applies that the greater the pole pitch TP, the higher the maximum achievable speed for a defined load on the transport unit TEi and vice versa. However, if necessary, the known field-weakening mode of the long-stator linear motor must be taken into account here, with which the maximum achievable speed can be increased yet further under a defined load of the transport unit TEi. Under certain circumstances, therefore, a certain overlap region may result, in which a transport unit TEi having a smaller pole pitch TP in field-weakening mode can reach a higher maximum speed than with a relatively greater pole pitch TP without the field-weakening mode. If, however, the transport unit TEi is operated at a different pole pitch TP in each case in field-weakening mode, the transport unit TEi having the greater pole pitch TP will generally reach the higher maximum speed under a defined load. By increasing the pole pitch TP, a higher current can be impressed upon the drive coils 3 than with a smaller pole pitch TP in the region of the voltage limit at the same speed of the transport unit TEi.

This follows from the formula below,

U=R*i+j*ω*L*i+ω*Ψ_{P}

Here, U is the coil voltage applied to the drive coils 3, ω is the frequency, L is the inductance of the drive coils 3, i is the coil current, R is the electrical resistance and Ψ_{P} is the interlinked magnetic flux. The first voltage term (R*i) is proportional to the coil current i and can be disregarded for the objective considerations. The first voltage term becomes zero during idling (current i=0). The second voltage term (j*ω*L*i) corresponds to the self-induction voltage and also becomes zero during idling (load or coil current i=0) of the long-stator linear motor. The third voltage term (ω*Ψ_{P}) corresponds to the so-called mutual induction voltage, which is independent of the impressed coil current i. The mutual induction voltage is the decisive variable for idling.

As the pole pitch TP is increased, this reduces the frequency co. In normal operation (at a certain load), this means that the second voltage term (i*ω*L*i) becomes smaller due to the lower frequency co, as a result of which a higher current i can be impressed upon the drive coils 3. As a result, for example, at the same speed of a transport unit TEi, a greater driving force can be generated with a greater pole pitch TP than with a smaller pole pitch TP. On the other hand, this current advantage can also be utilized to operate the transport unit TEi in field-weakening mode and thus to increase the maximum achievable speed under a defined load. However, if the transport unit TEi is not operated in field-weakening mode, then the idling speed is generally lower for a greater pole pitch TP than for a smaller pole pitch TP (the idling speed, analogously to the idling rotational speed for the rotary electric motor, is understood to be the speed at which the load or current i is zero). This can be explained by the fact that the increase in the pole pitch TP generally also increases the magnetic flux Ψ_{P}, as a result of which the reduction in the frequency co may be fully or partially compensated or overcompensated under certain circumstances.

In summary, this means that, in the context of the invention, the maximum speed of the transport unit TEi can be increased by increasing the pole pitch TP under certain conditions. However, it should be noted that, inter alia, this can generally result in reduced positional accuracy of the transport unit TEi.

A second transport unit TE2 with a number j₂=4 of magnetic poles 5 and a third transport unit TE3 with a number j₃=3 of magnetic poles 5 are shown on the transport device 1 shown in FIG. 1. The magnetic poles 5 of the second transport unit TE2 have a second pole pitch TP₂ and the magnetic poles 5 of the third transport unit TE3 have a third pole pitch TP₃, which is greater than the second pole pitch TP₂. For a predetermined constant coil pitch TS of the drive coils 3 of the transport path 2 and predetermined energy and structural boundary conditions (maximum coil current, maximum coil voltage, constant air gap), the maximum achievable speed of the third transport unit TE3 for a given same load is therefore generally greater than that of the second transport unit TE2 (possibly taking into account the field-weakening mode). An increase in the number j of magnetic poles 5 of a transport unit TEi (with the same pole pitch TP) has substantially no influence on the maximum achievable speed of the transport unit TEi in each case, but it influences the maximum achievable driving force of the relevant transport unit TEi. For a given structural design of the magnetic poles 5 (e.g. in terms of their magnetic field strength, pole width b, pole pitch TP), the maximum driving force can therefore be increased at a constant maximum speed and vice versa when the number j of magnetic poles 5 is increased.

At a given pole pitch TP, the pole width b of a magnetic pole 5 is advantageously selected such that, as far as possible, there is no gap between two adjacent magnetic poles 5 or that any construction-related gap between magnetic poles 5 is minimized. The pole width b then substantially corresponds to the pole pitch TP and the longitudinal extension L of all the magnetic poles 5 of a transport unit TEi essentially corresponds to the sum of the pole widths b of the magnetic poles 5, generally L=Σb*j. For example, two transport units TEi could have a substantially equal longitudinal extension L of the magnetic poles 5, but with a different number j of magnetic poles 5 and a different pole pitch TP, as shown by the second and third transport units TE2, TE3 in FIG. 1. On the second transport unit TE2, j=4 magnetic poles 5 are provided at a constant pole pitch TP₂, with the longitudinal extension being L₂=4*T_{P2}. On the third transport unit TE3, j=3 magnetic poles 5 are provided at a constant pole pitch TP₃, with the longitudinal extension being L₃=3*T_{P3}, where L₂=L₃. If the magnetic poles 5 of a transport unit TEi are spaced apart by a gap having the gap width s, the longitudinal extension L results from the sum of the pole widths b and the sum of the gap widths s to give L=Σb+Σs.

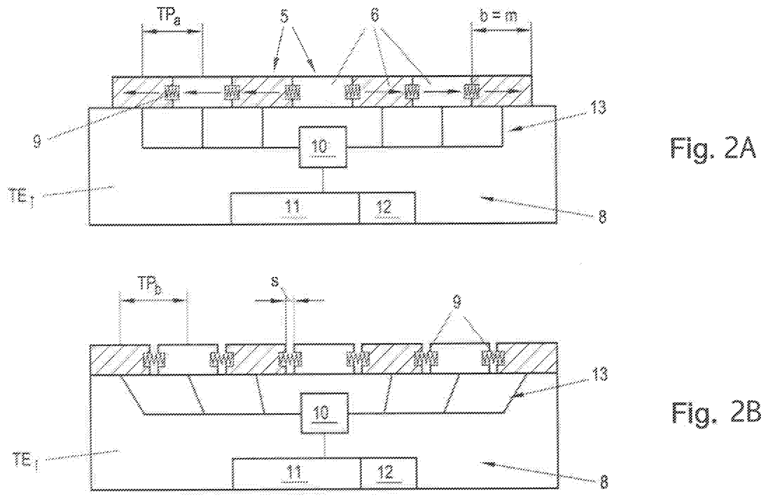

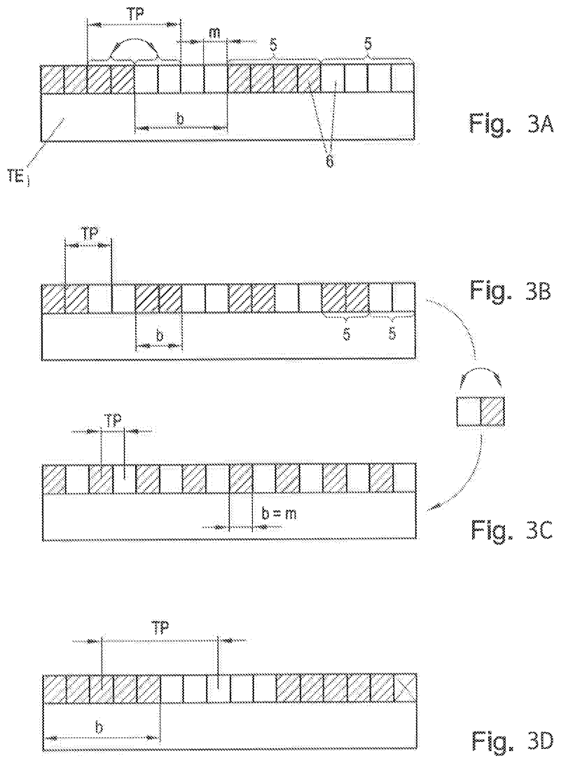

According to an advantageous embodiment of the invention, the number j of the magnetic poles 5 and/or the pole pitch TP and/or the pole width b of the magnetic poles 5 can be changed on at least one transport unit TEi in order for it to be possible to adjust the maximum speed at a given load or to adjust the accuracy of the transport unit TEi simply and flexibly to given boundary conditions. The adjustability can take place, for example, when the transport unit TEi is stationary on the transport path 2 or the transport unit TEi could be removed from the transport path 2 in order to carry out the adjustment of the number j of the magnetic poles 5, the pole width b or the pole pitch TP. However, it is particularly advantageous for the adjustment to be carried out directly on the transport path 2 during the movement of the transport unit TEi. An advantageous option for implementing the adjustability in concrete terms is explained in greater detail below with reference to FIGS. 2a-2b and 3a-3d. The pole pitch TP is advantageously adjusted such that the pole pitch TP differs as far as possible from the coil pitch TS of the drive coils 3 over the entire transport path 2 (with the coil pitch TS preferably being constant over the entire transport path 2). As a result, the magnetic poles 5 of a transport unit TEi can each be prevented from being directly opposite a drive coil 3 of the transport path 2, a result of which “cogging” of the transport unit TEi can be prevented. Of course, it may temporarily be the case that the pole pitch TP is equal to the coil pitch TS of the drive coils 3, for example if the pole pitch TP is adjusted during the movement of the transport unit TEi from a pole pitch TP<TS to a pole pitch TP>TS. The range TP=TS occurs only briefly during the actual adjustment process and therefore does not affect the movement of the transport unit TEi, or only affects it to a very limited extent.

FIG. 2A is a plan view of a transport unit TEi. The transport unit TEi has j=7 magnetic poles 5, which are arranged one behind the other in the longitudinal direction. Here, the magnetic poles 5 each have one permanent magnet 6, with adjacent permanent magnets 6 having opposite polarity or opposite magnetization directions, as shown by the cross-hatched areas. However, more than one permanent magnet 6 could also be provided per magnetic pole 5, with the permanent magnets 6 of a magnetic pole 5 having the same polarity or the same magnetization direction. The magnetic poles 5 have a pole width b and are spaced apart at a constant pole pitch TPa. Since each magnetic pole 5 is formed by a permanent magnet 6, in this case the pole width b corresponds to the magnet width m of a permanent magnet 6. The magnetic poles 5 are arranged such that they directly adjoin one another, i.e. substantially without a gap between the magnetic poles 5.

In order to adjust the position of the magnetic poles 5 in the longitudinal direction, an adjusting device 8 is provided on the transport unit TEi. The adjusting device 8 may, for example, be designed as a purely mechanical adjusting device 8 or may be electromechanical. In the simplest case, it would e.g. be conceivable for the adjusting device 8 to be designed as a type of guide rail, in which the magnetic poles 5 are displaceably arranged. In order to adjust the pole pitch TP, the transport unit TE1 could be removed from the transport path 2 and the magnetic poles 5 could be moved manually in the guide rail, brought into the desired position, and fixed again. In order to fix the position of the magnetic poles 5, suitable (not shown) retaining elements are of course provided on the transport unit TEi. As a result, the pole pitch could be increased very simply from the first pole pitch TPa to a second pole pitch TPb, as shown in FIG. 2B. When changing the position of the magnetic poles 5 having a fixed pole width b, there is of course a certain gap having a gap width s between the magnetic poles 5.

Another option would be e.g. that spring elements 9 (shown in FIG. 2A+2B) are provided between the magnetic poles 5, by which the pole pitch TP can be adjusted from the first (small) pole pitch TPa to the second (greater) pole pitch TPb. For this purpose, the spring elements 9 could be pre-tensioned, for example in the position of the magnetic poles 5 according to FIG. 2A, with the magnetic poles 5 being fixed in position by suitable (not shown) retaining elements such as pins. By a suitable triggering unit (not shown), the retaining elements could be released, as a result of which the magnetic poles 5 are forced apart due to the spring force of the spring elements 9 and the second pole pitch TPb (FIG. 2B) is set. Of course, suitable retaining elements, such as pins, could be provided for fixing in the position according to FIG. 2B. In a corresponding design of the spring elements 9, retaining elements and the trip unit, further adjustability to a greater third pole pitch TPc>TPb could, of course, also be implemented therewith. The triggering unit can in turn be triggered manually by the transport unit TEi being removed from the transport path 2.

However, in a corresponding arrangement and design of the triggering unit, the triggering could also be carried out with the transport unit TEi arranged on the transport path 2 when stationary or during the movement of the transport unit TEi. If the adjustment is intended to be carried out during the movement of the transport unit TEi, a suitable actuating unit could e.g. be provided at a desired triggering point on the transport path 2, which actuates the triggering unit when the transport unit TEi passes the triggering point. As an alternative mechanical adjusting device 8, however, a type of rod assembly 13 or generally a transmission could for example be provided, by which the magnetic poles 5 could be adjusted substantially continuously by a suitable drive. Of course, the embodiments mentioned are only to be understood as examples, and many other variants of the specific embodiment of the mechanical adjusting device 8 would be conceivable, from which a person skilled in the art can select a suitable variant.

Instead of a purely mechanical adjusting device 8, however, an electromechanical adjusting device 8 could also be provided on the transport unit TEi. It would be conceivable, for example, for a central actuator 10 to be provided, for example in the form of a suitable, preferably electrically actuatable actuator, by which the position of the magnetic poles 5 can be adjusted. As an actuator, an electromagnetic, pneumatic, hydraulic or a piezoelectric actuator could be used, for example. The central actuator 10 could in turn actuate a rod assembly 13 (or another type of transmission) in order to adjust the pole pitch TP of the magnetic poles 5. Of course, instead of the central actuator 10, a separate actuator could be provided per magnetic pole 5 or per permanent magnet 6 or, analogously to the spring elements 9, a suitable actuator could be provided between the magnetic poles 5 in each case. For actuation, a control unit 11 is preferably arranged on the transport unit TEi, which accordingly controls the adjusting device 8 in order to set a desired pole pitch TP.

For supplying power to the control unit 11 and the actuator 10 (or a plurality of actuators), a power storage device 12, e.g., a battery or other suitable device, may be arranged on the transport unit TEi. In addition to pure regulation in the sense of setting predetermined pole pitches TP, it would of course also be conceivable for a suitable controller for controlling the pole pitch TP to be integrated in the control unit 11. For example, it would be conceivable for the pole pitch TP not to be set in a fixed manner, but rather for the pole pitch TP to be adjusted by the control unit 11 on the basis of a target maximum speed of the transport unit TEi. The control unit 11 may also communicate with the control unit 7 of the transport device for this purpose, for example to receive a target value or actual value. However, actual values for the control, such as an actual speed, could also be determined on the transport unit TEi itself, for example by a suitable sensor system. Similarly to the purely mechanical adjusting device 8 described above, it would also be conceivable, in the electromechanical embodiment, for the control unit 11 to act as a triggering unit and for an actuating unit to be arranged on the transport path 2 at a specific triggering point. When the transport unit TEi passes the actuating unit, an electrical signal could e.g. be transmitted to the control unit 11 and the control unit 11 actuates the actuator 10 in order to adjust the magnetic poles 5 according to the desired pole pitch TP.

For example, the transport path 2 could have a return portion for returning unloaded transport units TEi. Accurate regulation of the position or speed of the transport unit TEi does not play a significant role on the return portion, but it may merely be desired, for example, to move the transport units TEi back to a specific starting point on the transport path 2 as quickly as possible, for example back to a point at which the transport units are loaded again with an object. In this case, the trigger point could be arranged at the start of the return portion of the transport path 2, in order to increase the pole pitch TP in the region of the return portion and thus to increase the maximum speed. At the end of the return portion, the pole pitch TP could be reduced again to the original pole pitch TP. If, for example, wireless communication is provided between the control unit 7 of the transport device and the control unit 11 of the transport unit TEi, the pole pitch TP can also be adjusted independently of trigger points at any other point on the transport path 2.

FIG. 3A-3D show a further advantageous embodiment of the invention. The transport unit TEi in FIG. 3A has a number j=4 of magnetic poles 5, each magnetic pole 5 consisting of a number p=4 of permanent magnets 6. In total, therefore, sixteen permanent magnets 6 are arranged on the transport unit TEi one behind the other in the longitudinal direction, each permanent magnet 6 having a magnet width m. The permanent magnets 6 of a magnetic pole 5 have an identical polarity, as symbolized by the cross-hatching, in order to form the magnetic pole 5. In order to change the number j of the magnetic poles 5 and/or the pole pitch TP and/or the pole width b, the magnetic properties of the individual permanent magnets 6 can be changed. For this purpose, the permanent magnets 6 are made of a suitable magnetizable material, for example AlNiCo. The change in the magnetic properties is to be understood to mean, for example, the change in the magnetic field strength of the permanent magnets 6. This may mean that the polarity of one or more permanent magnets 6 is reversed (in the sense of a reversal of the north and south poles) and/or that the magnetic field strength of the permanent magnets 6 is varied or that the permanent magnets 6 are demagnetized. Of course, a combination is conceivable, for example a polarity reversal with a reduction or increase in the magnetic field strength. However, in this context, demagnetization should not necessarily be understood to mean an absolute demagnetization (in the sense that the magnetic field strength is zero), since this is difficult to achieve in practice (in particular in a short time) due to the magnetic hysteresis. It may therefore be sufficient for the magnetic field strength to be reduced to the extent that the relevant permanent magnet 6 no longer makes a significant contribution to generating the driving force of the relevant transport unit TEi. In order to change the magnetic properties of the permanent magnets 6, in each case a permanent magnet 6 or a group of permanent magnets 6 is exposed to an external magnetic field which is sufficiently strong to change the magnetization direction of the permanent magnet(s) 6 (polarity reversal) and/or to change the magnetic field strength and/or to demagnetize the permanent magnet(s) 6. Alternatively, however, the permanent magnets 6 could also be arranged on the transport unit TEi so as to be exchangeable and instead of the magnetic polarity reversal could be exchanged in order to achieve the desired change in the number j of the magnetic poles 5 or the pole pitch TP or the pole width.

The transport unit TEi in FIG. 3B has, for example, a number j=8 of magnetic poles 5, each consisting of p=2 permanent magnets 6. In comparison with FIG. 3A, the number j of the magnetic poles 5 has thus doubled with an unchanged number of a total sixteen permanent magnets 6, the pole pitch TP and the pole width b having been halved. Starting from FIG. 3A, the permanent magnets 6 could always be accordingly reversed in polarity in pairs in order to arrive at the embodiment according to FIG. 3B or the permanent magnets 6 could be exchanged in pairs, as shown by the double-headed arrow in FIG. 3A. Analogously, the number j of the magnetic poles 5 can be further increased while simultaneously reducing the pole pitch TP and the pole width b, as shown in FIG. 3C. Here, each magnetic pole 5 is formed by a permanent magnet 6, and therefore the transport unit TEi has a number j=16 of magnetic poles 5, and the pole pitch TP and the pole width b correspond to the magnetic width m of a permanent magnet 6. Starting from FIG. 3B, the variant according to FIG. 3C can be achieved by, for example, exchanging individual permanent magnets 6 in each case or by reversing the polarity thereof. Of course, in addition, the magnetic field strength of the permanent magnets 6 could also be changed, for example, in order to make it possible to generate a greater driving force.

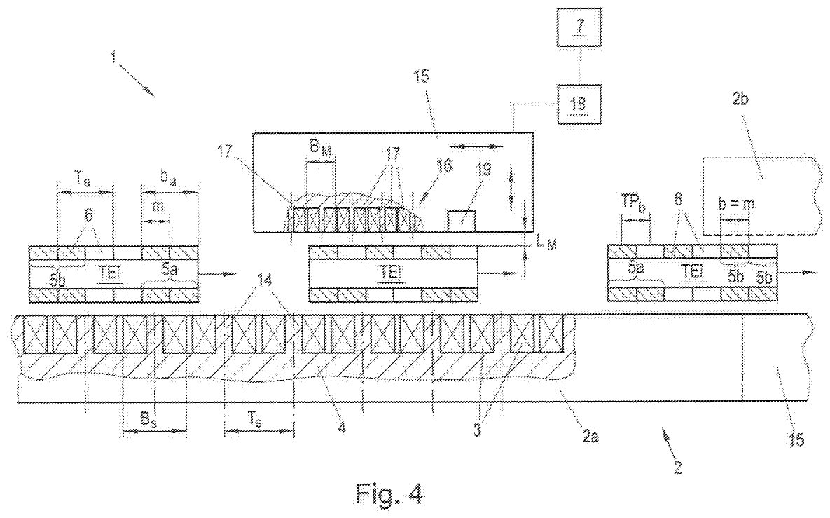

Finally, FIG. 3D shows a transport unit TEi with a number j=3 of magnetic poles 5, the number p of permanent magnets 6 being unchanged at p=16. Since the p/j ratio of the number p=16 of permanent magnets 6 to the number j of magnetic poles 5 does not result in an integer in this case, only five permanent magnets 6 having the same polarity are provided per magnetic pole 5, resulting in a total of 15 permanent magnets 6 for the three magnetic poles 5. The remaining permanent magnet 6 (in this case the far right-hand permanent magnet) is preferably not used here as part of a magnetic pole 5 in order to achieve a constant pole pitch TP and pole width b and can either be removed or demagnetized, which in turn can be carried out by a suitable external magnetic field. Since absolute demagnetization can often be difficult to achieve in practice due to magnetic hysteresis, it may of course be sufficient for the magnetic field strength to be reduced to the extent that the corresponding permanent magnet 6 no longer makes a significant contribution to generating the driving force. In the example according to FIG. 3D, the pole pitch TP and the pole width b correspond to the sum of the magnet widths m of the five permanent magnets 6. It is thus clear that the number j of the magnetic poles 5, the pole pitch TP and the pole width b can be adapted very flexibly by exchanging or remagnetizing or demagnetizing the permanent magnets 6 of a transport unit TEi. However, by contrast with remagnetizing or demagnetizing, the manual exchange of individual permanent magnets 6 cannot be carried out during the movement of the transport unit TEi on the transport path 2. How the remagnetization or demagnetization of the permanent magnets 6 can be carried out on the transport device is explained in greater detail below with reference to FIG. 4.

FIG. 4 shows a detail of a transport device 1 in the region of a straight transport path portion. The drive coils 3, which are usually spaced apart at a constant distance of the coil pitch TS in the longitudinal direction and have a specific set coil width Bₛ, are arranged on the transport path 2 in a known manner. The drive coils 3 may e.g. be substantially circular and may be arranged around teeth 14 of the ferromagnetic core 4. In this case, a magnetization device 15, which is provided for the remagnetization or demagnetization of the permanent magnets 6 of the transport unit TEi, as was described with reference to FIG. 3A-3D, is arranged in parallel with the transport path 2. In this case, the magnetization device 15 is provided for transport units TEi having magnetic poles 5 arranged on either side, as they are used for a transport path 2 in a double-comb design, for example in the transport path portion A in FIG. 1. The magnetization device 15 can be designed as a separate unit, as shown in FIG. 4, but could also be integrated in a transport path, for example, as shown in FIG. 1 by the dashed region on the second transport path portion 2b.

In order not to impede the movement sequence of the remaining transport units TEi on a transport path 2, the magnetization device 15 could for example also be arranged on a specially provided transport path portion (not shown), in the manner of a “siding”. For example, the transport unit TEi of which the permanent magnets 6 are intended to be remagnetized or demagnetized could be moved by a switch from the closed transport path 2 onto the separate transport path portion and could be remagnetized or demagnetized on said path by the magnetization device 15, while the remaining transport units TEi can continue their predetermined movement on the transport path unimpeded. When the remagnetization or demagnetization is completed, the corresponding transport unit TEi can be moved from the separate transport path portion in the opposite direction back to the closed transport path 2, which in turn can be carried out by the switch for the transport path portion in the form of a “siding”. However, the transport path portion could also be designed as a parallel portion having two switches, with the transport unit TEi being able to be moved via a first switch from the transport path onto the parallel transport path portion, then along the parallel transport path portion to the magnetization device 15 and via a second switch in the same direction of movement back to the transport path 2. As a result, it would also be possible, for example, for a plurality of transport units TEi to be sequentially remagnetized or demagnetized without impeding each other when moving back to the transport path 2.

The transport unit TEi in FIG. 4 has a number p=6 of permanent magnets 6 on either side in each case, which form first magnetic poles 5a (on the left in the direction of movement) and second magnetic poles 5b (on the right in the direction of movement). When viewed in the direction of movement (arrow in FIG. 4) in front of the magnetization device 15, the first and second magnetic poles 5a, 5b are each formed by two permanent magnets 6 having the same polarity and preferably the same magnetic field strength. Therefore, in front of the magnetization device 15 on either side, the transport unit TEi has an identical number j=3 of magnetic poles 5 having a first pole pitch TPa and a first pole width bₐ, the pole width bₐ corresponding to the width of two permanent magnets 6 (b=2m). The first pole pitch TPa substantially corresponds to the first pole width bₐ, since the permanent magnets 6 substantially directly adjoin one another without a gap. The transport unit TEi can be moved in a known manner by the interaction of the magnetic poles 5a with the drive coils 3 of the transport path 2 in the direction of movement, as symbolized by the arrows on the transport units TEi.

The magnetization device 15 comprises a magnetization unit 16, which is designed here in the form of a plurality of magnetization coils 17. The magnetization coils 17 are arranged in a similar manner as the drive coils 3 of the transport path 2 in the longitudinal direction one behind the other on the magnetization device 15 and each have a specific magnetization coil width B_{M}. The magnetization coils 17 are designed such that they can generate a sufficiently strong magnetic field, which is suitable for changing the magnetic properties of the permanent magnets 6 of the transport unit TEi, i.e. for example for reversing the polarity or for demagnetization. The magnetization device 15 is arranged in the transverse direction such that a specific magnet gap L_{M} is provided between the magnetization coils 17 and the permanent magnet 6. In order to improve the effect of, for example, the polarity reversal or demagnetization, it is advantageous for the magnet gap L_{M} to be as small as possible, because, as a result, the magnetic field generated by the magnetization coils 17 can be better impressed upon the permanent magnets 6 (smaller magnet gap L_{M} means lower magnetic resistance). It is particularly advantageous for the magnet gap L_{M} to be completely prevented and the permanent magnets 6 to abut the magnetization coils 17 substantially directly, because this can reduce, in particular prevent, the magnetic resistance of the magnet gap.

The magnetization coil width B_{M} is advantageously selected on the basis of the magnet width m of the permanent magnets 6 of the transport unit TEi. It; for example, it is desired that each individual permanent magnet 6 can be reversed in polarity or demagnetized, the magnetization coil width B_{M} is preferably intended to be at most the magnet width in (B_{M}≤m), in order not to likewise reverse the polarity of any permanent magnets 6 adjoining the permanent magnet 6 to be reversed in polarity. Of course, this is not entirely accurate, but for example depends on whether a gap is provided between the permanent magnets or whether the permanent magnets 6 are substantially directly adjacent to each other, as shown in FIG. 4. Of course, this restriction is not absolutely necessary, and the magnetization coil width B_{M} of the magnetization coils 17 could of course also be selected to be larger; advantageously, the magnetization coil width B_{M} is an integer multiple of the magnet width m (B_{M}˜x*m; x∈ [symbol] ), with the maximum magnetization coil width B_{M} being intended to be selected such that at least two magnetic poles 5 can be produced from the available number p of permanent magnets 6; in the example shown, the maximum magnetization coil width B_{M} would therefore be B_{M}=3*m.

The polarity reversal or the demagnetization or generally the change in the magnetic properties of the permanent magnets 6 can be carried out when the transport unit TEi is stationary, but can also be carried out during the movement of the transport unit TEi along the transport path 2, for example if the magnetization device 15 itself can be moved in parallel with the transport path 2, as shown by the double-headed arrow in FIG. 4. In this case, the movement is preferably carried out at the same speed as that at which the transport unit TEi is moved along the transport path 2. After reversing the polarity (in FIG. 4, center+right), the transport unit has an unchanged number j=3 of magnetic poles 5, each with a number p=2 of permanent magnets 6, on the side facing the transport path 2. On the opposite side of the transport unit TEi, on which the polarity reversal (in the sense of a reversal of north and south poles) is carried out by the magnetization device 15, the transport unit TEi then has a number j=6 of magnetic poles 5, which each consist of a permanent magnet 6. Of course, instead of reversing the polarity, a change in the magnetic field strength of the permanent magnets 6 could again take place, with preferably all the permanent magnets 6 of a transport unit TEi having an equal magnetic field strength. The transport unit TEi could then be moved, for example, into a transport path portion in the form of a double comb, as shown by the dashed second transport path portion 2b. The transport unit TEi could then be moved by interaction of the drive coils 3 of the second transport path portion 2b and a further magnetization device 15 could be integrated in the first transport path portion 2a, as shown in FIG. 4.

Of course, the magnetization unit 16 does not have to have a plurality of magnetization coils 17, as shown, but instead it could, for example, also be sufficient for only one magnetization coil 17 to be arranged in the magnetization unit 16. The transport unit TEi would then be moved on the transport path 2 such that in each case a permanent magnet 6 to be reversed in polarity is acted upon by the magnetization coil 17, and once the polarity reversal is complete, the transport unit TEi would be moved onwards by a corresponding distance in order to bring the next permanent magnet 6 or the next group of permanent magnets 6 into the range of the magnetization coil 17, etc. In addition to the polarity reversal, a change in the magnetic field strength or a demagnetization would of course also be possible. The movement of the transport unit TEi can be controlled in a conventional manner via the control unit 7 of the transport device 1. The magnetization device 15 can be controlled for example by a magnetization control unit 18 provided inside or outside the magnetization device 15.

The magnetization control unit 18 may also be connected to the control unit 7 of the transport device 1, for example to obtain position data of the transport units TEi or target values for the polarity reversal or demagnetization. Such desired values may e.g. be a desired number j of magnetic poles 5, a pole pitch TP or pole width b of a specific transport unit TEi. The magnetization control unit 18 can then, for example based on the obtained target values, correspondingly actuate the magnetization unit 16, in particular the magnetization coils 17 provided therein, for example with a specific voltage, a current and a current direction, in order to achieve die desired polarity reversal and/or the change in the magnetic field strength or demagnetization of the permanent magnets 6 associated with the magnetization coils 17. Of course, the magnetization device 15 can also be supplied with power via the magnetization control unit 18 or also by a separate power supply (not shown). Furthermore, the magnetization device 15 may also comprise one or more sensors 19, which are for example provided for determining a position of the transport unit TEi relative to the magnetization device 15, in particular relative to the magnetization coils 17. This allows for very accurate synchronization between the permanent magnets 6 and the magnetization coils 17. Of course, the sensor(s) 19 may in turn also be connected to the magnetization control unit 18. Based on the position signal from the sensor(s) 17, the magnetization control unit 18 could control the control unit 7 of the transport device 1, which controls the position of the transport unit TEi to synchronize the permanent magnets 6 and the magnetization coils 17.

If the magnetization device 15 itself is designed to be movable in the longitudinal direction, as shown by the horizontal double-headed arrow in FIG. 4, the polarity reversal and/or the change in the magnetic field strength or the demagnetization could also be carried out during the movement of the transport unit TEi. As a result, movement sequences of the transport device 1 can be further optimized in terms of time, because the transport unit TEi is not required to be stationary. The movement of the magnetization device 15 can in turn be controlled by the magnetization control unit 18, a corresponding guide device (not shown) and a suitable drive of course being provided. In order to keep the magnet gap L_{M} as small as possible, which is advantageous for a rapid and effective change of the magnetic properties (polarity reversal/demagnetization/change in the magnetic field strength), it would also be conceivable, for example, for the magnetization device 15 to be designed to be movable in the transverse direction, in addition to the longitudinal movement (or independently thereof when the magnetization device 15 cannot move in the longitudinal direction), as shown by the vertical double-headed arrow in FIG. 4. When a transfer unit TEi to be reversed in polarity is positioned in the magnetization device 15 and is accordingly synchronized with the magnetization coils 17, the magnetization device 15 can be moved in the transverse direction towards the transport unit TEi to reduce the magnet gap L_{M} Preferably, the magnet gap L_{M} is minimized to a magnet gap L_{M}=0 in order to produce direct contact between magnetization coils 17 and permanent magnets 6, as a result of which the process of polarity reversal/demagnetization can be improved, in particular accelerated.

However, the magnetization device 15 does not necessarily have to be designed as a fixed component of the transport device 1, as shown in FIG. 4, but instead it could also be designed, for example, as an external portable unit which can be used as needed for the polarity reversal or demagnetization of the permanent magnets 6 of the transport units TEi. This can be carried out directly on the transport path, similarly to that shown in FIG. 4, but could also take place away from the transport path 2. e.g. before a corresponding transport unit TEi is arranged on the transport path 2 or if a transport unit TEi is removed from the transport path 2. Of course, a separate operating unit (not shown) could be arranged on the magnetization device 15, by which a user can implement settings relating to the desired polarity reversal/demagnetization.

According to a further advantageous embodiment of the magnetization device 15, the magnetization device 15 is integrated directly in the transport path 2 of the transport device 1, as shown by the dashed region at the right-hand end of the transport path 2 in FIG. 4 (see also second transport path portion 2b in FIG. 1). In this case, for the change in the magnetic properties (polarity reversal/demagnetization/change in the magnetic field strength) of the permanent magnets 6, the drive coils 3 of the transport path 3 can be used and no separate magnetization coils 17 are required. The drive coils 3 can be designed accordingly in order to generate a sufficiently strong magnetic field that is suitable for the polarity reversal or demagnetization of the permanent magnets 6. This means that, with a corresponding structural design of the drive coils 3 and corresponding actuation of the drive coils 3, substantially the entire transport path 2 can be used as the magnetization device 15.

If the coil width Bₛ of the drive coils 3 is greater than the magnet width m of the permanent magnets 6 of the transport unit TEi, it may be the case that not every permanent magnet 6 can be reversed in polarity individually, but rather that the permanent magnets 6 can be reversed in polarity only in pairs or in groups under certain circumstances. If, nevertheless, individual polarity reversal of individual permanent magnets 6 is desired, which increases the flexibility with respect to the number j of magnetic poles 5, pole pitch TP and pole width b, a limited portion of the transport path 2 could for example be designed as the magnetization device 15, the coil width B_{S} of the drive coils 3 in this portion being smaller than the coil width B_{S} of the remaining drive coils 3 of the transport path 2 and preferably substantially corresponding to the magnetic width m of the permanent magnets 6.

Of course, position synchronization is also advantageous for the magnetization device 15 that is integrated in the transport path 2, in order to bring the drive coils 3 provided for polarity reversal into alignment with the corresponding permanent magnets 6. This can again be carried out by the magnetization control unit 18 and corresponding sensors 19 or also directly by the control unit 7 of the transport device 1. If the transport path 2 is modularly constructed from individual transport segments TSi arranged one behind the other in the longitudinal direction, it would be conceivable, for example, for a transport segment TSi to be designed as a magnetization device 15. As a result, for example, an existing transport path 2 can be easily extended by a magnetization device 15, for example by exchanging a conventional transport segment TSi with a transport segment in the form of a magnetization device 15, as shown in FIG. 1 on the basis of the transport segment TS3.

A memory (not shown), e.g., a non-transitory computer readable medium or media, can be provided to store a set of instructions that can be executed by a processor of the control unit 7 to actuate and/or control coils 3 and/or of control unit 11 to control adjusting device 8 to set pitch so as to perform any of the methods or processes defined as computer based functions, either alone or in combination with the other described devices. The memory, accessible by the processor, can be part of control unit 7 and/or part of control unit 1 and/or remote from control unit 7 and/or control unit 11, e.g., a remotely located server, memory, system, or communication network or in a cloud environment.

Moreover, in addition to the foregoing, it is to be understood and those skilled in the art will readily appreciate that the blocks and/or modules illustrated in the drawings, e.g., control units 7 and 11 are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. Further, these blocks and/or modules can be formed as application specific integrated circuits (ASICs) or other programmable integrated circuits, and, in the case of the blocks and/or modules, which can be implemented by microprocessors or similar, they may be programmed using software (e.g., microcode) to perform various functions discussed herein and may optionally be driven by firmware and/or software. Alternatively, each block and/or module may be implemented by dedicated hardware, or as a combination of dedicated hardware to perform some functions and a processor (e.g., one or more programmed microprocessors and associated circuitry) to perform other functions.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A transport device in the form of a long-stator linear motor, comprising:
a transport path along which at least two transport units can be moved in the longitudinal direction,
a plurality of drive coils being arranged one behind the other in the longitudinal direction on the transport path and
a plurality of magnetic poles being arranged one behind the other in the longitudinal direction on the transport units at a specific pole pitch in each case, which interact electromagnetically with the drive coils to move the transport units), each magnetic pole comprising at least one permanent magnet,
wherein the magnetic poles of the at least two transport units have a different pole pitch.

2. A transport device according to claim 1, wherein the at least two transport units have a different number of the magnetic poles and/or in that the magnetic poles of the at least two transport units have a different pole width.

3. A transport device according to claim 1, wherein a number (j) of the magnetic poles and/or the pole pitch and/or a pole width of the magnetic poles can be changed on at least one transport unit during the movement of the transport unit along the transport path and/or when stationary.

4. A transport device according to claim 3, wherein at least one permanent magnet of a transport unit is interchangeable for changing the number of the magnetic poles and/or the pole pitch and/or the pole width of the magnetic poles.

5. A transport device according to claim 3, wherein a magnetization device is provided in the transport device for changing the number of the magnetic poles and/or the pole pitch and/or the pole width of the magnetic poles, by which magnetization device magnetic properties of at least one permanent magnet of a transport unit can be changed, the magnetization device being integrated in the transport path of the transport device or being arranged in parallel with the transport path.

6. A transport device according to claim 5, wherein the magnetization device comprises a magnetization unit and a magnetization control unit, the magnetization unit being provided to generate a magnetic field in order to change magnetic properties of at least one permanent magnet of the transport unit, in order to change the pole pitch of the magnetic poles, and in that the magnetization control unit is provided for actuating the magnetization unit.

7. A transport device according to claim 6, wherein the magnetization unit is provided to generate a magnetic field in order to change magnetic properties of at least one permanent magnet of the transport unit in order to change a number of the magnetic poles and/or a pole width (b).

8. A transport device according to claim 6, wherein the magnetization unit comprises at least one magnetization coil for generating the magnetic field, the at least one magnetization coil preferably having a magnetization coil width which corresponds to a magnet width of a permanent magnet of the transport unit or an integer multiple of the magnet width of a permanent magnet of the transport unit.

9. A transport device according to claim 6, wherein the magnetization device is integrated in the transport path, wherein at least one of the drive coils of the transport path is designed as a magnetization coil of the magnetization unit or in that the magnetization device is arranged in parallel with the transport path, the magnetization device being stationary or movable relative to the transport path in order to change the magnetic properties of at least one permanent magnet of the transport unit when stationary or during the movement of the transport unit.

10. A transport device according to claim 3, wherein a position of at least one permanent magnet in the longitudinal direction of the transport unit can be changed by an adjusting device arranged on the transport unit for changing the pole pitch of the magnetic poles of a transport unit.

11. A transport device according to claim 1, wherein a coil pitch of the drive coils in the longitudinal direction along the transport path differs from the pole pitch of the transport units, the coil pitch preferably being constant over the entire transport path.

12. A transport unit for a transport device in the form of a long-stator linear motor, comprising:
a plurality of magnetic poles arranged one behind the other in the longitudinal direction of the transport unit at a specific pole pitch, each magnetic pole comprising at least one permanent magnet,
wherein the pole pitch of the magnetic poles of the transport unit can be changed.

13. A transport unit according to claim 12, wherein an adjusting device is provided on the transport unit, by which device a position of at least one of the permanent magnets in the longitudinal direction of the transport unit can be changed in order to change the pole pitch of the magnetic poles.

14. A transport unit according to claim 13, wherein the adjusting device is mechanically constructed, the adjusting device comprising a transmission or a rod assembly and/or at least one spring element for adjusting the pole pitch or in that the adjusting device is electromechanically constructed and comprises at least one electromechanical actuator, a control unit for actuating the at least one actuator being provided on the transport unit in order to change the pole pitch.

15. A transport unit according to claim 13, wherein the transport unit comprises a triggering unit for triggering the adjustment of the pole pitch, it being possible to actuate the triggering unit manually or by an actuating unit of a transport device in the form of a long-stator linear motor.

16. A transport unit according to claim 12, wherein at least one permanent magnet of the transport unit is exchangeable for changing the pole pitch and/or a number of the magnetic poles and/or a pole width of the magnetic poles and/or in that the magnetic properties of at least one permanent magnet can be changed by a magnetization device.

17. A method for operating a transport device in the form of a long-stator linear motor, comprising a transport path comprising a plurality of drive coils arranged one behind the other in the longitudinal direction and comprising a plurality of transport units comprising a plurality of magnetic poles that are arranged one behind the other in the longitudinal direction at a specific pole pitch and each comprising at least one permanent magnet which interacts electromagnetically with the drive coils in order to move the transport unit along the transport path, the method comprising:
at least two transport units are used in the transport device, the magnetic poles of which have a different pole pitch.

18. The method according to claim 17, wherein the pole pitch and/or a number of the magnetic poles and/or a pole width of the magnetic poles is changed on at least one transport unit during the movement of the transport unit along the transport path and/or when stationary.
